(19) United States
(12) Patent Application Publication
(10) Pub. No.: US 2015/0246362 A1
(43) Pub. Date: Sep. 3, 2015

(54) HYDROPHILIC ELECTRET MEDIA

(71) Applicant: Kimberly-Clark Worldwide, Inc., Neenah, WI (US)

(72) Inventors: Roger B. Quincy, III, Cumming, GA (US); Catherine J. Turnbow, Cumming, GA (US)

(73) Assignee: Kimberly-Clark Worldwide, Inc., Neenah, WI (US)

(21) Appl. No.: 14/193,354

(22) Filed: Feb. 28, 2014

(51) Int. Cl. B03C 3/28; A47L 13/20; D06M 15/00; B05D 5/00

(52) U.S. Cl. CPC B03C 3/28; B05D 5/00; A47L 13/20; D06M 15/00; D06M 2101/20

(57) ABSTRACT

The present disclosure describes a surfactant treatment for a polyolefinic nonwoven fabric used as a filtration medium or for collecting dust and dirt, e.g. as a mop or similar device. The surfactant treatment consists essentially of carbon, hydrogen and oxygen atoms. The surfactant treated material has a BFE after electret treatment of at least 97 percent and is hydrophilic.

### BACKGROUND

This disclosure relates to the production of a media suitable for electret treatment.

Media that have been given electret treatment may be used as filters to remove contaminants from air as well as being used as dirt and dust particle collectors in other forms, such as mops. The media for these applications is often polyolefin nonwoven fabrics, particularly meltblown fabrics. The polyolefinic fabric media is designed to be hydrophobic in its base (untreated) state in an effort to resist moisture, since moisture is known to degrade the filtration efficiency due to electret fouling. It would be useful to have hydrophilic electret filtration media for specific applications, such as a mop designed to collect dust and dirt particles while also being able to remove liquid spills.

### SUMMARY

This disclosure describes hydrophilic electret fabrics that provide exceptional filtration and dust and dirt collection properties. There is a surfactant treatment for a polyolefinic nonwoven fabric that may be used as a filtration medium or for collecting dust and dirt, e.g. as a mop, a wipe for surface cleaning or similar device. The base polyolefinic nonwoven fabric is hydrophobic and is treated prior to electret treatment with a surfactant that consists essentially of carbon, hydrogen and oxygen atoms.

This disclosure also describes a nonwoven fabric that has the dried residue of an aqueously applied surfactant treatment prior to electret treatment. The surfactant treatment is essentially free of silicon, potassium, phosphorus and sulfur.

The fabrics treated as disclosed herein may be used in dust and dirt collection devices and as filter material.

### DETAILED DESCRIPTION

It is to be understood that the following description is only exemplary of the principles of the present disclosure, and should not be viewed as narrowing the pending claims. Those skilled in the art will appreciate that aspects of the various embodiments discussed may be interchanged and modified without departing from the scope and spirit of the disclosure.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting sheet. Spunbond fibers are generally continuous and have average diameters (from a sample of at least 10) larger than 7 microns, more particularly, between about 10 and 20 microns. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting sheet to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting sheet.

The permeability of a nonwoven material may range from 25 to about 500 cubic feet per minute (CFM) as characterized in terms of Frazier permeability. For example, the permeability of the nonwoven material may range from 50 to about 400 cubic feet per minute. As yet another example, the permeability of the nonwoven material may range from 100 to about 300 cubic feet per minute. The Frazier permeability, which expresses the permeability of a material in terms of cubic feet per minute of air through a square foot of area of a surface of the material at a pressure drop of 0.5 inch of water (or 125 Pa), was determined utilizing a Frazier Air Permeability Tester available from the Frazier Precision Instrument Company and measured in accordance with Federal Test Method 5450, Standard No. 191A. When the nonwoven material contains SMS material(s) having basis weights ranging from about 1 osy (33 gsm) to about 2.6 osy (87 gsm), the permeability of the nonwoven material may range from about 20 cubic feet per minute to about 75 cubic feet per minute when determined generally in accordance with ISO 9237:1995 (measured with an automated air permeability machine using a 38 cm² head at a test pressure of 125 Pa,—exemplary air permeability machine is TEXTEST FX 3300 available from TEXTEST AG, Switzerland). If multiple plies or layers of SMS material are used to provide basis weights ranging from about 2 osy (67 gsm) to about 5 osy (167 gsm), the permeability of the nonwoven material may range from about 10 cubic feet per minute to about 30 cubic feet per minute when determined generally in accordance with ISO 9237:1995.

There are a number of methods of characterizing the air filtration efficiencies of nonwoven webs. One method uses a TSI, Inc. (St. Paul, Minn.) Model 8130 Automated Filter Tester (AFT). This test (the TSI test) is less expensive than the BFE test, and while less accurate, gives directional and relative indications of filtration efficiency. The Model 8130 AFT measures pressure drop and particle filtration characteristics for air filtration media. The AFT utilizes a compressed air nebulizer to generate a sub-micron aerosol of sodium chloride particles which serves as the challenge aerosol for measuring filter performance. The characteristic size of the particles used in these measurements was 0.1 micrometer. Typical air flow rates were between 31 liter per minute and 85 liters per minute. The AFT test was performed on a sample area of 140 square cm. The performance or efficiency of a filter medium is expressed as the percentage of sodium chloride particles which penetrate the filter. Penetration is defined as transmission of a particle through the filter medium. The transmitted particles were detected downstream from the filter. The percent penetration (% P) reflects the ratio of the downstream particle count to the upstream particle count. Light scattering was used for the detection and counting of the sodium chloride particles.

Bacterial filtration efficiency (BFE) employs a test where samples are challenged with a biological aerosol of Staphylococcus aureus and the results employ a ratio of the bacterial challenge counts to sample effluent counts, to determine percent bacterial filtration efficiency (% BFE). For the tests herein, a suspension of S. aureus was aerosolized using a nebulizer and delivered to the test article at a constant flow rate. The aerosol droplets were drawn through a six-stage, viable particle Andersen sampler for collection. This test procedure allows a reproducible bacterial challenge to be delivered to the nonwoven material and complies with ATSM F2101 (Nelson Lab #373162). The testing herein was performed by Nelson Laboratories, Inc., Salt Lake City, Utah, according to “Bacterial Filtration Efficiency,” Procedure No. SOP/ARO/007L.1.

The Andersen sampler is known in the art and is used to collect viable samples of airborne bacteria and fungal spores. The samples can act as a measure of the number of bacteria or fungal spores in the air at a specific location and time. The sampler works through impaction in which air is drawn through a sampling head with 400 small holes at constant rate (in this case 28.3 L/min or 1 cubic foot per minute) for a known period of time. Before sampling a media plate is placed inside the sampling head and as air is pulled through the holes heavier particles such as bacteria and fungal spore's impact on the agar surface and stick there. The air continues through the sampler and into the pump. After sampling the plate can be removed for culturing.

It has been found that electret treatment increases the BFE of a fabric. Electret treatment is described, for example, in U.S. Pat. No. 5,592,357. Electret treatment is used to produce an intense corona current at reduced voltages to help reduce the potential for arcing and provide a more efficient, stable discharge at atmospheric pressure, for electrostatically charging an advancing web or film. Once ionization occurs, excess charged particles cannot be lost until they collide with a solid body, preferably the remaining electrode, achieving the desired result. It has been found that this applies to both AC and DC voltages.

Placement of a thin non-electron absorbing gas layer in the vicinity of an electrode is advantageously accomplished by various means. For example, the charging bar can be replaced with a longitudinally extending tube having spaced apertures for delivering a gas to the discharge-forming elements of the electrode. These discharge-forming elements can include either a series of pins which extend through the spaced apertures of the tube, or a series of nozzles which project from the surface of the tube. In either case, this places the gas in the vicinity of the pins, or the nozzles, which in turn receive appropriate biasing voltages for developing the electric field which is to produce the improved discharge. Alternatively, the charging shell can be replaced with a hollow body which similarly incorporates a series of apertures, and a cooperating series of pins or nozzles, to achieve a similar result.

Surfactant treatments for the nonwoven material were investigated to produce a hydrophilic electret material. The material used was a 2.57 osy (87 gsm) SMS except for Sample 1 which was a 1.85 osy (62.7 gsm) SMS. The surfactant treatment was applied to the material by a dip and squeeze (saturation) process, using an aqueous formulation containing the surfactant. The amount of surfactant treatment in weight percent is indicated in the Sample descriptions below for the treated and dried material. The material having the dried surfactant treatment residue was subjected to electret treatment as indicated in the Table. TSI and BFE were tested according to the procedures above. The wettability to water was assessed for the samples by placing drops of distilled water on the fabric surface. The amount of surfactant used for the samples was adjusted to give uniform and complete wet out by the drops of water. A sample determined to be wettable to water is considered to be hydrophilic.

Samples with treatments investigated include the following:
1. Quadrastat® PIBK at 0.8% add on: Quadrastat® PIBK is the tradename for an aqueous formulation that contains 50% of potassium isobutyl phosphate available from Manufacturers Chemical, LLC, of Cleveland, Tenn. The data in the table is based on five samples.
2. Quadrastat® PIBK at 3.0% add on. The data in the table is based on five samples.
3. Masil® SF-19 at 0.8% add on: MASIL® SF 19 is a low toxicity silicone surfactant with high thermal stability combining the advantages of dimethyl silicone fluids with conventional, nonionic surfactants. This product has a polydimethyl-siloxane backbone modified via the chemical attachment of polyoxyalkylene chains. MASIL® SF 19 provides reduced surface tension in aqueous and non-aqueous systems, lubricity, and flow and leveling in a variety of coatings, textile, plastic and personal care applications. The data in the table is based on four samples.
4. DOSS 70D at 0.7% add on. Doss 70D is a dialkyl sulfosuccinate anionic surfactant available from Manufacturers Chemicals LLC. The data in the table is based on four samples.
5. Cirrasol® PP862 at 1.0% add on: Cirrasol® PP862 is a non-ionic surfactant that is a blend of hydrogenated ethoxylated castor oil and sorbitan monooleate and is available from Croda International PLC of East Yorkshire, England. The data in the table is based on five samples.
6. Pluronic® P123 at 0.34% add on: Pluronic® P-123 is the tradename for a triblock copolymer manufactured by the BASF Corporation. The nominal chemical formula is HO(CH₂CH₂O)₂₀(CH₂CH(CH₃)O)₇₀(CH₂CH₂O)₂₀H, which corresponds to a molecular weight of around 5800 Da. Triblock copolymers based on poly(ethylene glycol)-poly(propylene glycol)-poly(ethylene glycol) are known generically as poloxamer, and similar materials are manufactured by other companies. The data in the table is based on five samples.
7. Pluronic® P123 at 0.6% add on. The data in the table is based on five samples.
8. Pluronic® P123 at 1.8% add on. The data in the table is based on five samples.
9. Pluraflo® L1060 at 0.5% add on: Pluraflo® L1060 is a non-ionic dispersant (i.e. surfactant) of an ethylene oxide propylene oxide block co-polymer and is available from the BASF Corporation of Florham Park, N.Y. The data in the table is based on four samples.
10. No treatment: No surfactant treatment is added to the base fabric prior to electret treatment. The data in the table is based on five samples.

| Sample | | | | | |
|---|---|---|---|---|---|
| number, | | | | Post | |
| from | Electret | Pre-elec. | Post-elec. | electret | Wettability |
| above | conditions | TSI | TSI | BFE | to water? |
| 1 | D | 20.1 ± 0.9 | 20.4 ± 0.7 | | NO |
| 2 | C | 17.0 ± 0.2 | 16.4 ± 0.4 | 90 | YES |
| 3 | E | 20.4 ± 1.0 | 35.0 ± 21.1 | | YES |
| 4 | B | 20.9 ± 0.4 | 21.7 ± 0.7 | | YES |
| 5 | A | 18.8 ± 0.9 | 73.2 ± 1.1 | | YES |
| 6 | F | 21.9 ± 0.7 | 59.2 ± 0.8 | 99.1 | YES |
| 7 | F | 21.7 ± 0.6 | 59.1 ± 1.3 | 99.9 | YES |
| 8 | F | 35.9 ± 12.2 | 54.0 ± 1.5 | | YES |
| 9 | A | 36.9 ± 8.5 | 60.9 ± 3.5 | | YES |
| 10 | A | 41.2 ± 1.5 | 68.1 ± 1.4 | 99.9 | NO |

Electret conditions:
A—13.75 kV, 1.0 mA
B—15 kV, 1.5 mA
C—Average of 13 kV, 1 mA and 12.5 kV, 0.7 mA
D—12 kV, 0.7 mA
E—12 kV, 1.0 mA
F—13.75 kV, 11.25 mA

As can be seen from the results, the first four samples, containing elements other than simply carbon, hydrogen and oxygen, had a very small increase in TSI after electret treatment. This indicates that the BFE results would likely also be poor as shown by sample 2. BFE was not run for the other samples that showed poor TSI results due to the high cost for this test. Beginning with sample 5, however, the difference between the pre- and post-electret TSI was significant. The BFE data that was collected also showed good results, post-electret treatment.

Electret treatment is used, as discussed above, to increase the BFE of a fabric. This treatment also increases the TSI. It is not believed that differing electret treatment conditions had a great effect on these result and is reported merely for thoroughness. The data shows that the treatments containing other than carbon, hydrogen and oxygen (C—H—O) atoms do not show an appreciable increase in TSI after electret treatment, indicating that they do not allow the fabric to hold a charge and are therefore unsuitable for electret charging. Samples 1, 2 and 4 have little or no positive change in TSI after electret treatment. Note that sample three does show an average increase in TSI but the range of results is extremely wide, leading to questions about repeatability and the value of such results. The successful candidates display large increases in TSI after electret treatment, showing that they allow the web to absorb the charge needed to increase the barrier to microbial infiltration.

Regardless of the mechanism of operation, it is clear that the treatments for Samples 5-9 that are surfactants containing only carbon, hydrogen and oxygen (C—H—O) atoms are superior to other treatments containing silicon, phosphorus, sulfur and the like, though amounts above 1.5 appear to be less promising. Treatments that are C—H—O surfactants that are essentially free of silicon, potassium, phosphorus and sulfur provide superior TSI NaCl filtration compared to the other treatments 1-4. The preferred amount of surfactant add on is between a positive amount and 1 weight percent or at most 1.5% but must also make the material hydrophilic.

As used herein and in the claims, the term “comprising” is inclusive or open-ended and does not exclude additional unrecited elements, compositional components, or procedure steps.

While various patents have been incorporated herein by reference, to the extent there is any inconsistency between incorporated material and that of the written specification, the written specification shall control. In addition, while the disclosure has been described in detail with respect to specific embodiments thereof, it will be apparent to those skilled in the art that various alterations, modifications and other changes may be made to the disclosure without departing from the spirit and scope of the present disclosure. It is therefore intended that the claims cover all such modifications, alterations and other changes encompassed by the appended claims.

What is claimed is:

1. A surfactant treatment for a polyolefinic nonwoven fabric material consisting essentially of carbon, hydrogen and oxygen atoms, wherein said material has a BFE after electret treatment of at least 97 percent and is hydrophilic.

2. A dust and dirt collection device comprising the nonwoven material of claim 1.

3. A filter material comprising the nonwoven material of claim 1.

4. The treatment of claim 1 wherein said treatment is applied at a rate of between a positive amount and 1 weight percent.

5. A nonwoven material having thereon the dried residue of an aqueously applied surfactant treatment that is essentially free of silicon, potassium, phosphorus and sulfur, wherein said material has a BFE after electret treatment of at least 97 percent and is hydrophilic.

6. A dust and dirt collection device comprising the nonwoven material of claim 5.

7. A filter material comprising the nonwoven material of claim 5.

8. The treatment of claim 5 wherein said treatment is applied at a rate of between a positive amount and 1 weight percent.
